(19) United States
(12) Patent Application Publication
(10) Pub. No.: US 2016/0169129 A1
(43) Pub. Date: Jun. 16, 2016

(54) ENERGY STORAGE ADVISEMENT CONTROLLER FOR A VEHICLE

(71) Applicants: Hyundai America Technical Center, Inc., Superior Township, MI (US); Hyundai Motor Company, Seoul (KR); Kia Motors Corporation, Seoul (KR)

(72) Inventors: Allan Lewis, Windsor (CA); Nayan Engineer, Canton, MI (US)

(21) Appl. No.: 14/569,100

(22) Filed: Dec. 12, 2014

(51) Int. Cl. F02D 41/00

(52) U.S. Cl. CPC F02D 41/0007

(57) ABSTRACT

An energy storage advisement (ESA) controller assists with operation of a vehicle having a turbine for generating electricity from engine exhaust, a storage device for storing the electricity, and a compressor driven by the storage device for turbo charging the engine. The ESA controller includes a memory configured to store program instructions and a processor configured to execute the program instructions. The program instructions, when executed, are configured to: receive first data related to a pathway upon which the vehicle is travelling and second data related to vehicle dynamics; calculate a first and second control signals based on the first and second data, wherein the first control signal is for modifying operation of the turbine and the second control signal is for modifying operation of the compressor; and provide the control signals to a power distribution module for controlling the turbine and compressor for efficient operation of the engine.

### BACKGROUND

1. Field of the Disclosure

The present disclosure relates to systems and methods for efficiently operating a vehicle, and more particularly, to an energy storage advisement (ESA) controller for adapting operation based on horizon information. A typical vehicle has a turbine for generating electricity from engine exhaust, a storage device for storing the electricity, and a compressor driven by the storage device for turbo charging the engine.

2. Description of the Prior Art

Various attempts have been successful in improving the operating efficiency of a vehicle. For example, U.S. PG Pub. No. 2012/0221234 ('234 Publication) discloses managing fuel quantity to increase efficiency while maintaining drivability. The '234 Publication evaluates the information to provide recommended fuel stop locations with recommended amounts of fuel to intake. Other attempts include U.S. Pat. Nos. 8,371,121; 7,210,296; and 6,735,515.

### SUMMARY

The prior art does not envision review of horizon data and engine parameters to modify engine operation for improved efficiency. Improved efficiency allows for benefits such as downsizing the engine itself, reduced emissions, and smoother performance.

The objects of the present disclosure are not limited to the above-mentioned objects, and, not mentioned, other objects and advantages of the present disclosure can be understood by the following description, and they will become apparent by exemplary embodiments of the present disclosure. In addition, it will be seen that the objects and advantages of the present disclosure can be realized by the technology described herein, in the claims and combination thereof.

According to the present disclosure, there is an energy storage advisement (ESA) controller for assisting with operation of a vehicle having an engine, a turbine for generating electricity from engine exhaust, a storage device for storing the electricity, and a compressor driven by the storage device for turbo charging the engine. The ESA controller includes a memory configured to store program instructions and a processor configured to execute the program instructions. The program instructions, when executed, are configured to: receive first data related to a pathway upon which the vehicle is travelling and second data related to vehicle dynamics; calculate a first and second control signals based on the first and second data, wherein the first control signal is for modifying operation of the turbine and the second control signal is for modifying operation of the compressor; and provide the control signals to a power distribution module for controlling the turbine and compressor for efficient operation of the engine.

Preferably, the first data includes road map data, altitude data (including road elevation), speed limit data, traffic signal data, or combinations thereof and the second data includes a state of charge of the storage device, speed of the vehicle data, or combinations thereof. The program instructions may also determine a state of charge of the storage device and apply at least one threshold to determine if at least one of charging or discharging energy from the storage device is proper. Still further, the program instructions may transmit the control signals to the vehicle from a remote location.

Still further, the energy storage advisement controller may calculate a time to a speed changing event so that modifications to operation occur in real time. The energy storage advisement controller may also maintain fuel data, determine remaining travel distance based on the fuel data, determine a fuel-up distance to a nearest opportunity for refuel from map data, and modify engine operation for maximum fuel efficiency based on comparing the remaining travel distance to the fuel-up distance. Additionally, the energy storage advisement controller may maintain fuel data, determine a remaining travel distance based on the fuel data, and switch to operating the engine in a maximum fuel efficiency mode if the remaining travel distance falls below a limit.

The subject technology is also directed to a non-transitory computer readable medium containing program instructions executed by an energy storage advisement controller to accomplish any or all of the calculations and operations described herein.

### BRIEF DESCRIPTION OF THE DRAWINGS

The above and other objects, features and advantages of the present disclosure will be more apparent from the following detailed description taken in conjunction with the accompanying drawings.

FIG. 1 is schematic diagram of a system for a vehicle with an energy storage advisement (ESA) controller according to an exemplary embodiment of the present disclosure.

FIG. 2 is a schematic diagram illustrating more detailed data flow between elements of the system of FIG. 1 according to an exemplary embodiment of the present disclosure.

FIG. 3 is a somewhat schematic view of a vehicle travelling along a road, such vehicle having an (ESA) controller according to an exemplary embodiment of the present disclosure.

FIG. 4 is another schematic diagram illustrating system logic in the system of FIG. 1 according to an exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present disclosure may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The foregoing objects, features and advantages will be more apparent through the detailed description as below with reference to the accompanying drawings, and thus the those skilled in the art can be easily embody the technical spirit of the present disclosure. Further, in the following description of the present disclosure, if it is determined that the detailed description for the known art related to the present disclosure unnecessarily obscures the gist of the present disclosure, the detailed description thereof will be omitted. Hereinafter, with reference to the accompanying drawings, preferred embodiments of the present disclosure will be described in detail when like reference numerals refer to similar elements.

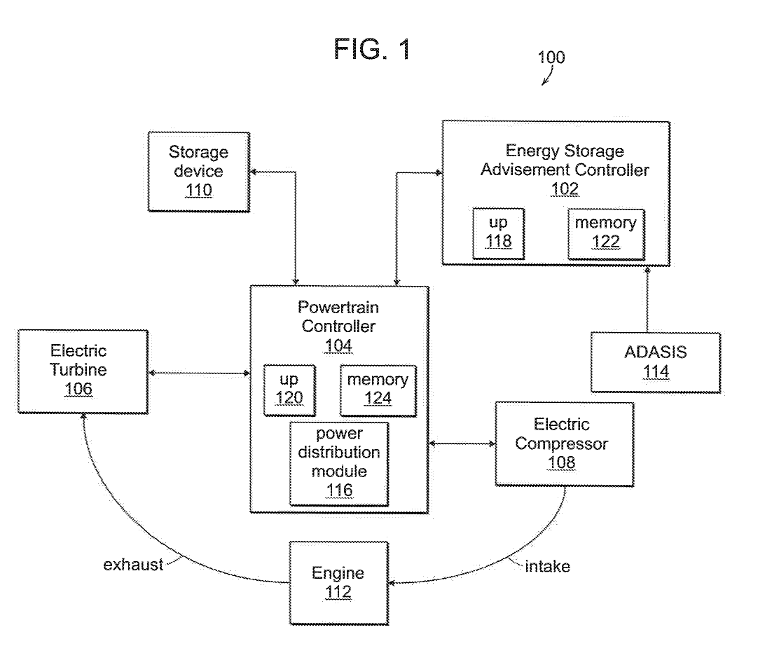

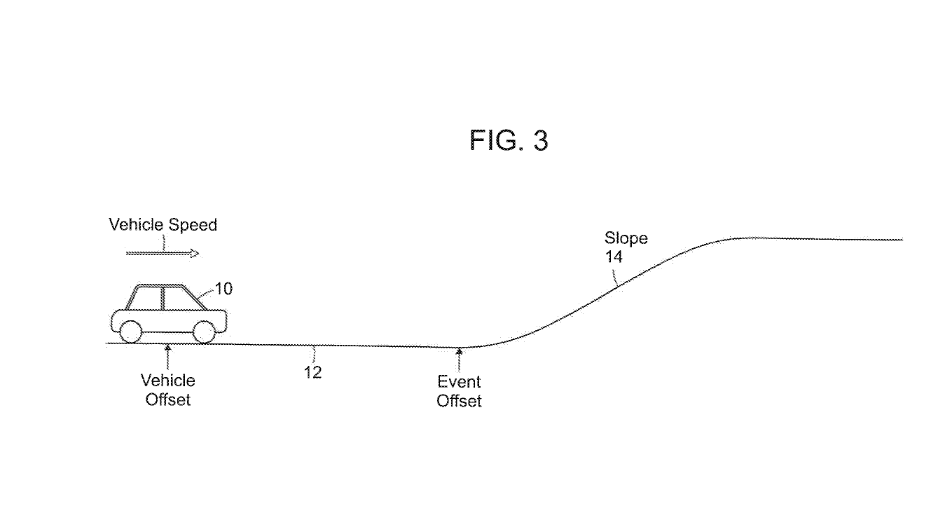

FIG. 1 is schematic diagram of a system 100 for a vehicle 10 (shown in FIG. 3) with an energy storage advisement (ESA) controller 102 according to an exemplary embodiment of the present disclosure. As shown in FIG. 1, the system 100 includes a powertrain controller 104 in communication with the ESA controller 102. The powertrain controller 104 modifies operation of an electric turbine 106 and compressor 108 based on control signals received from the ESA controller 102.

The powertrain controller 104 also communicates with an energy storage device 110 such as a battery. The powertrain controller 104 also includes a power distribution module 116 to coordinate operation of the electric turbine 106 and electric compressor 108. At various times depending upon the control signals, the electric turbine 106 is utilized to generate electricity from exhaust from an engine 112. The electricity may be stored in the energy storage device 110. Similarly, at various times depending upon the control signals, the energy storage device 110 powers the electric compressor 108 to provide a turbo boost to the engine 112.

The system 100 also includes an advanced driver assistance system interface specification (ADASIS) module 114 in communication with the ESA controller 102. The ADASIS module 114 is an industry platform created in 2002 in Europe to facilitate providing horizon information to drivers. The horizon information includes such data as digital maps, position data using a global positioning system so that the extended horizon may be utilized. Although the ADASIS module 114 is shown, various other similar technologies now known and later developed could be used equally as effectively in the subject technology. Additionally, the ADASIS module 114, the powertrain controller 104 and ESA controller 102 are shown as distinct but may be combined in part or in whole depending upon preferred hardware and software arrangements. As shown in FIG. 1, the ESA controller 102 and powertrain controller 104 each have respective processors 118, 120 in communication with associated memory 122, 124.

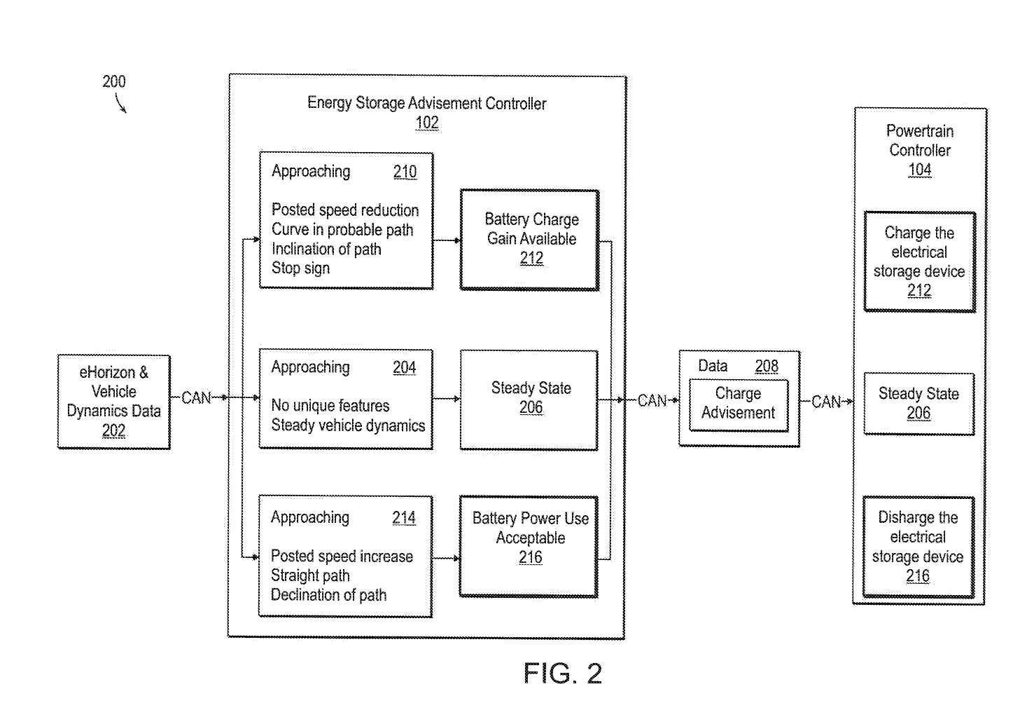

Referring now to FIG. 2, a schematic diagram 200 illustrating system information flow in the system 100 of FIG. 1 is shown. The system 100 preferably uses a CAN bus to transmit data between elements. It is also envisioned that the communication may be otherwise wired and/or wireless. The ESA controller 102 receives input data 202 from the powertrain controller 104 and the ADASIS module 114. The powertrain controller 104 provides vehicle dynamics such as the state of charge (SOC) of the storage device, amount of fuel, status of the electric turbine and electric compressor, and the like. The ADASIS module 114 provides eHorizon data such as current elevation, upcoming elevation along a plotted course and/or a likely course, and the like.

The ESA controller 102 processes the input data 102 to generate control signals for delivery to the electric turbine 106 and compressor 108 as charge advisement data 208. For example, if no unique features are upcoming and the vehicle dynamics are in a steady state, as shown in the circumstance box 204, the ESA controller 102 generates a steady state control signal 206. However, as the vehicle 10 approaches a change that reduces engine workload (e.g., posted speed limit reduction, pathway curve, inclination of the pathway, a stop sign, a traffic light etc.), as shown in circumstance box 210, the ESA controller 102 generates a battery charge gain available control signal 212. In other words, the ESA controller 102 recognizes and anticipates an opportunity to utilize the engine exhaust to power the electric turbine 106 and generate electricity to charge the storage device 110.

As the vehicle 10 approaches a change that increases engine workload (e.g., posted speed limit increase, a straight or straightening pathway, declination of the pathway etc.), as shown in circumstance box 214, the ESA controller 102 generates a battery use acceptable control signal 216. In other words, the ESA controller 102 recognizes and anticipates a need to utilize the storage device 110 to power the electric compressor 108 for turbo boosting the engine 112. The control signals 206, 212, 216 pass along the CAN bus as charge advisement data 208 for receipt by the powertrain controller 104. In turn, the powertrain controller 104 executes the desired modification of operation as indicated in the control signals 206, 212, 216.

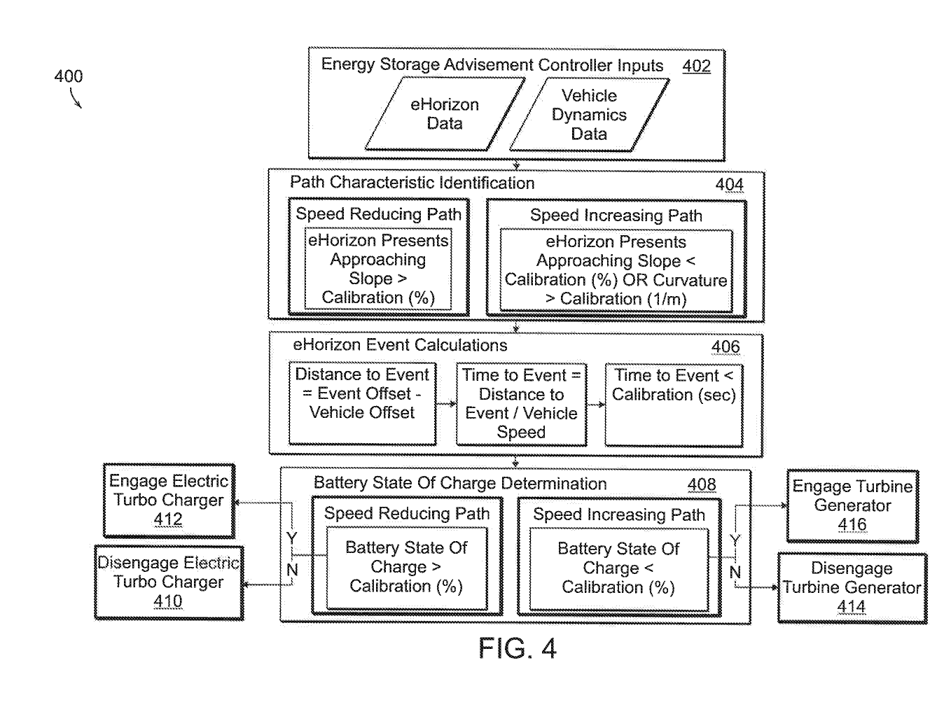

To further illustrate the subject technology by way of a specific example, FIGS. 3 and 4 are referred to. FIG. 3 is a somewhat schematic view of the vehicle 10 travelling along a road 12 with an upcoming event in the form of an upward slope 14. FIG. 4 is another schematic diagram 400 illustrating detailed system logic in the system of FIG. 1 according to an exemplary embodiment of the present disclosure. The vehicle 10 may have the ESA controller 102 in the engine compartment, trunk or other location so that input data can be received from the ADASIS module 114.

At step 402, the input data includes eHorizon data and vehicle dynamics data that allows the ESA controller 102 to calculate path characteristic identification as shown at step 404. The path or road 12 may be a speed reducing path or speed increasing path. As shown in FIG. 3, a speed reducing path is an approaching slope 14. However, not all events create modification of operation because the event is simply to minor to require adjustment or so varied that varying contradictory and inefficient adjustments would be required. For example, a predetermined threshold in the change of operation may be required in order for modification to occur. As shown at step 404, the threshold is represented as a calibration percentage. If the engine load reduction for the upcoming event is not greater than the calibration threshold, then no modification of operation occurs. Similarly, if the engine load increase for the upcoming event is less that the calibration threshold, then the ESA controller 102 does no modification.

At step 406, the ESA controller 102 performs eHorizon event calculations. Using the input data 402 from the ADASIS module 114, the distance to the slope 14 is calculated as the difference between the vehicle offset (e.g., vehicle position with respect to the slope 14) and event offset (e.g., point where the slope 14 begins). The vehicle dynamics data includes the vehicle speed so that once the distance to the slope 14 is known, the ESA controller 102 calculates the time to the speed reducing event. It is envisioned that these calculations are updated in realtime so that as minor speed changes occur, the calculations are updated for optimal accuracy.

At step 408, the ESA controller 102 utilizes additional information from the powertrain controller 104 such as the state of charge of the storage device 110. For a speed reducing event, the ESA controller 102 evaluates the state of charge. If the state of charge is low (e.g., below a calibration threshold), the flow 400 proceeds to step 410. At step 410, operation of the electric compressor 108 is prevented because of the insufficient power in the storage device 110. However, if the state of charge is high, the flow 400 proceeds to step 412 to engage the electric compressor 108. At step 412, the electric compressor runs off the storage device 110 and, in turn, provides additional power to the engine 112 as the vehicle 10 rides up the slope 14.

Referring again to step 408, for a speed increasing event, the ESA controller 102 also evaluates the state of charge. If the state of charge is high (e.g., above a calibration threshold), the flow 400 proceeds to step 414 when operation of the electric turbine 106 is prevented because of the storage device 110 is about full. Thus, the engine 112 may run efficiently. However, if the state of charge is low, the flow 400 proceeds to step 416 to engage the electric turbine 106 and, in turn, provide electricity for storage to the storage device 110 as the vehicle 10, for example, glides down a slope.

Additionally, the ESA controller 102 and/or powertrain controller 104 can execute engine tuning. For example, during downhill coasting, fuel can be cut off or during breaking, regenerative devices can be used to charge the storage device 110. The ESA controller 102 may collect data from the ADASIS module 114 or other sources to further identify upcoming events. For example, the ESA controller 102 may evaluate traffic data such as oncoming congestion that will create an event, traffic signals, particular vehicles on the same pathway that may be travelling at a slower speed or making frequent stops such as a school bus and the like. Although the ESA controller 102 has been depicted as associated with the vehicle 10, the ESA controller 102 may be remotely located and communicate with the vehicle 10 via other means such as a cellular network. In this case, a single ESA controller 102 may track and modify operation of a fleet of vehicles. Further, the ESA controller 102 may maintain fuel data. As various opportunities for refuel become apparent or if the remaining travel distance falls below a threshold, the ESA controller 102 may switch to operating the engine in a maximum fuel efficiency mode to help prevent running out of fuel.

As can be seen, the system 100 creates independence between generation (e.g., the electric turbine 106) and turbo boosting by the electric compressor 108. As such, the system 100 prepares for future engine loads and charging opportunities to efficiently and smoothly operate the engine 112. This increased fuel economy and performance of smartly managing the peak load situations allows optimally sizing the engine relative to the steady state loading expectations. As a result, smaller, less expensive combustion engines can be used with a corresponding green effect of reduced emissions.

### INCORPORATION BY REFERENCE

All patents, published patent applications and other references disclosed herein are hereby expressly incorporated in their entireties by reference.

As the above described, the present disclosure is not limited to the aforementioned exemplary embodiments and accompany drawings, since replacements, various modifications, and changes may be made without departing from the technical spirit of the present invention by those skilled in the art.

What is claimed is:

1. An energy storage advisement controller for a vehicle having an engine, a turbine for generating electricity from engine exhaust, a storage device for storing the electricity, and a compressor driven by the storage device for turbo charging the engine, the energy storage advisement controller comprising:
a memory configured to store program instructions; and
a processor configured to execute the program instructions, the program instructions, when executed, being configured to:
receive first data related to a pathway upon which the vehicle is travelling and second data related to vehicle dynamics;
calculate a first and second control signals based on the first and second data, wherein the first control signal is for modifying operation of the turbine and the second control signal is for modifying operation of the compressor; and
provide the control signals to a power distribution module for controlling the turbine and compressor for efficient operation of the engine.

2. An energy storage advisement controller as recited in claim 1, wherein the first data includes road map data, altitude data, speed limit data, traffic signal data, or combinations thereof.

3. An energy storage advisement controller as recited in claim 1, wherein the second data includes a state of charge of the storage device, speed of the vehicle data, or combinations thereof.

4. An energy storage advisement controller as recited in claim 1, wherein the program instructions when executed are further configured to determine a state of charge of the storage device and apply at least one threshold to determine if at least one of charging or discharging energy from the storage device is proper.

5. An energy storage advisement controller as recited in claim 1, wherein the program instructions when executed are further configured to remotely modify operation of a fleet of vehicles.

6. An energy storage advisement controller as recited in claim 1, wherein the program instructions when executed are further configured to calculate a time to a speed changing event so that modifications to operation occur in real time.

7. An energy storage advisement controller as recited in claim 1, wherein the program instructions when executed are further configured to maintain fuel data, determine remaining travel distance based on the fuel data, determine a fuel-up distance to a nearest opportunity for refuel from map data, and modify engine operation for maximum fuel efficiency based on comparing the remaining travel distance to the fuel-up distance.

8. An energy storage advisement controller as recited in claim 1, wherein the program instructions when executed are further configured to maintain fuel data, determine a remaining travel distance based on the fuel data, and switch to operating the engine in a maximum fuel efficiency mode if the remaining travel distance falls below a limit.

9. A non-transitory computer readable medium containing program instructions executed by an energy storage advisement controller, the computer readable medium comprising:
program instructions that receive first data related to a pathway upon which a vehicle is travelling and second data related to dynamics of the vehicle;
program instructions that calculate a first and second control signals based on the first and second data, wherein the first control signal is for modifying operation of a turbine of the vehicle and the second control signal is for modifying operation of a compressor of the vehicle; and
program instructions that provide the first and second control signals to a power distribution module of the vehicle for controlling the turbine and compressor for efficient operation of an engine of the vehicle, wherein the turbine generates electricity from engine exhaust for a storage device and the compressor is driven by the storage device for turbo charging the engine.

10. The non-transitory computer readable medium of claim 9, further comprising:
program instructions that, wherein the first data includes road map data, altitude data, speed limit data, traffic signal data, or combinations thereof.

11. The non-transitory computer readable medium of claim 9, further comprising:
program instructions that wherein the second data includes a state of charge of the storage device, speed of the vehicle data, or combinations thereof.

12. The non-transitory computer readable medium of claim 9, further comprising:
program instructions that determine a state of charge of the storage device and apply at least one threshold to determine if at least one of charging or discharging energy from the storage device is proper.

13. The non-transitory computer readable medium of claim 9, further comprising:
program instructions that remotely modify operation of a fleet of vehicles.

14. The non-transitory computer readable medium of claim 9, further comprising:
program instructions that calculate a time to a speed changing event so that modifications to operation occur in real time.

15. The non-transitory computer readable medium of claim 9, further comprising:
program instructions that maintain fuel data, determine remaining travel distance based on the fuel data, determine a fuel-up distance to a nearest opportunity for refuel from map data, and modify engine operation for maximum fuel efficiency based on comparing the remaining travel distance to the fuel-up distance.

16. The non-transitory computer readable medium of claim 9, further comprising:
program instructions that maintain fuel data, determine a remaining travel distance based on the fuel data, and switch to operating the engine in a maximum fuel efficiency mode if the remaining travel distance falls below a limit.
